(19) United States
(12) Patent Application Publication
(10) Pub. No.: US 2015/0235232 A1
(43) Pub. Date: Aug. 20, 2015

(54) SYSTEM AND METHODS FOR THE PRODUCTION AND MANAGEMENT OF BENEFITS FROM USE OF NATURAL SUBSTANCE

(71) Applicant: Platinum Star IP Partners, LLC, Albuquerque, NM (US)

(72) Inventors: Michael J. Meyer, Albuquerque, NM (US); Timothy J. Strosnider, Albuquerque, NM (US); Charles E. Christmann, Albuquerque, NM (US); Craig White, Albuquerque, NM (US)

(21) Appl. No.: 14/622,370

(22) Filed: Feb. 13, 2015

Related U.S. Application Data
(60) Provisional application No. 61/940,110, filed on Feb. 14, 2014.

(51) Int. Cl. G06Q 30/00; G06Q 50/02

(52) U.S. Cl. CPC G06Q 30/018; G06Q 50/02

(57) ABSTRACT

The present invention is a system and methods that facilitates the identification and management of benefits derived from the use of a naturally-occurring substance. Certain preferred embodiments of the present invention facilitate the identification of the characteristics and the tracking of the transport and use of the substance in order to define and monetize the benefits that the substance may provide given the context in which it used. Advantageously, certain preferred embodiments are directed to a system and methods by which the consequences of the use of a quantity of a certain natural substance used in an agricultural context can be quantified and monetized. Through the use of certain embodiments of the invention in agricultural production, a variety of benefits including reduce carbon emissions may be monetized and managed.

### CROSS REFERENCE TO RELATED APPLICATIONS

This application claims the benefit of U.S. Provisional Application No. 61/940,110 filed Feb. 14, 2014, which is incorporated by reference in its entirety.

### FIELD OF THE INVENTION

The present invention is a system and methods that facilitates the identification and management of benefits derived from the use of a naturally-occurring substance. Certain preferred embodiments of the present invention facilitate the identification of the characteristics and the tracking of the transport and use of the substance in order to define and monetize the benefits that the substance may provide given the context in which it used. Advantageously, certain preferred embodiments are directed to a system and methods by which the consequences of the use of a quantity of a certain natural substance used in an agricultural context can be quantified and monetized. Through the use of certain embodiments of the invention in agricultural production, a variety of benefits including reduced carbon emissions may be monetized and managed.

### BACKGROUND OF THE INVENTION

The earth's atmosphere is a complex gaseous system that is essential to support life on planet Earth. The atmosphere shields the planet from the harsh conditions that exist in space. The earth's atmosphere largely defines the planet's climate and acts like the glass in a greenhouse. In a greenhouse, energy from the sun passes through the glass and is absorbed by objects in the greenhouse including the plants and soil. Much of the absorbed energy is converted to heat, which warms the greenhouse. The glass helps maintain the greenhouse warmth by trapping this heat. While an estimated 31% of the energy received from the sun as sunlight is reflected back to space by the earth's atmosphere and surface (particularly those portions of the surface that are covered by snow and ice), 20% is absorbed by the atmosphere, and the remaining 39% portion of incoming radiation is absorbed by the earth's oceans and land, where it is converted into heat, warming the surface of the earth and the air above it. On an ongoing basis, the earth's average temperature is determined by the overall balance between the amount of energy that is received from the sun, the amount of radiant heat that is developed because of the atmosphere, and the amount that is reflected back to space. Certain naturally occurring gases in the atmosphere help to establish and maintain this balance. Water vapor is considered to be the largest contributor to the natural greenhouse effect. Other gases that naturally occur in smaller quantities in the atmosphere also contribute to the natural greenhouse effect. These gases include carbon dioxide, methane, and nitrous oxide. This natural balance, however, can be upset by a variety of factors including the overabundance of one or more of the natural greenhouse gases in the atmosphere.

The recent warming of the earth's climate has been largely attributed to human activity, primarily the release of greater amounts of carbon dioxide and other greenhouse gases (each a “GHG”) into the atmosphere. These gases enhance the insulating properties of the atmosphere, reducing heat loss, thereby warming the planet. Continued emission of these gases is the primary cause for concern about climate change now and into the immediate future. Particularly important is the emission of carbon dioxide, which is released through the combustion of carbon-based fossil fuels. In some countries, over 80% of total national greenhouse gas emissions are associated with the production or consumption of fossil fuels for energy purposes. Some examples of GHGs are carbon dioxide, methane, perfluorocarbons, nitrous oxide, sulfur hexafluoride, and hydroflurocarbons. The amount of global warming that a certain GHG can produce is often measured as the “carbon dioxide equivalent”, that is, in terms of the amount of warming potential that carbon dioxide would produce.

A variety of strategies and policies have been proposed over the years by which the “carbon footprint”—that is, the amount of greenhouse gas emitted by a specific source—can be identified and reduced.

On a larger scale, governments have taken steps to limit emissions of carbon dioxide and other greenhouse gases. The reduction of the emission of greenhouse gases and global warming was a subject addressed at the 1992 United Nations Conference on Environment and Development. From this Conference, the United Nations Framework Convention on Climate Change resulted. This Treaty called for protocols to take place from time to time, the most famous of which is the Kyoto Protocol. This Protocol committed countries that became parties to the Treaty to reduce greenhouse gas emission based on the premises that global warming is occurring and the man-made carbon dioxide has caused it. Governments have also implemented a variety of measures to limit emissions of carbon dioxide and other greenhouse gases and, in some cases, put taxes on carbon emissions and higher taxes on fossil fuels.

A variety of individual and industrial strategies and policies have been proposed over the years to reduce greenhouse gas emissions. Individuals and companies are attempting to curb global warming by various conservation measures, recycling programs, driving and flying less, using lower amounts of highly processed products and components, and sourcing product and components locally. Much of these commonly adopted measures focus on reducing transportation and therefore the release of carbon dioxide and other gases from the combustion of fossil fuels to reduce greenhouse gas emissions. However, reductions in other economic sectors can produce significant reduction in greenhouse gas emissions.

The emissions from the agricultural sector are known to be very substantial. It is estimated that one fifth of all global GHG emissions are currently due to agriculture. Forty percent of this amount comes from direct agricultural production, another forty percent is caused by agriculture's role in driving deforestation and the loss of peat and fires, and twenty percent is caused by the use of fossil fuels along the agricultural supply chain and for on-farm machinery. Direct agricultural production emissions include two important greenhouse gases: nitrous oxide (N₂O) and methane (CH₄). Nitrous oxide is estimated to have a global warming potential that is 310 times that of carbon dioxide. Methane is estimated to have a global warming potential that is 23 times that of carbon dioxide.

The causes of some of these large amounts of GHG emissions are known and therefore may be susceptible to reduction. For example, 15% of direct agricultural emissions are due to the use of synthetic fertilizers. Synthetic fertilizers are problematic because coal is often used in the production of this product, particularly in developing countries, instead of the more efficient natural gas. Also, farmers tend to over apply nitrogen fertilizers to crops as insurance against low yields. However, by applying large amounts of nitrogen fertilizer to crops, the potent GHG nitrous oxide may be emitted similarly in large amounts.

Similarly, irrigation is also known to cause GHG emissions. The need to obtain and distribute water for crops in areas that do not have ready sources of water requires that fossil fuels be used not only to build but also to operate the pumps and other components of the irrigation systems.

The steps that can be taken to change current practices in the agricultural sector and reduce the GHG emissions by this sector are often known. For example, a reduction in the over application of synthetic fertilizers can be realized if farmers adopt better accounting practices by which they know how much fertilizer is needed for a particular crop and when that amount has been applied. To illustrate, it is thought that China—considered, like the U.S., and to a lesser degree, India, and the E.U., to be a “hotspot” for nitrogen fertilizer overuse—could reduce fertilizer application rates by 30 to 60 percent without harming yields. Switching to organic fertilizers can also help simply because lower amounts of fossil fuels are needed to produce them.

Better water management practices and the improvement of agricultural soils can similarly reduce the need for and constant operation of irrigation systems and thereby GHG emissions.

The steady growth of GHG emissions may also be curtailed if agricultural output is intensified rather than expanded. Expansion requires the conversion of more land to agricultural purposes. Such conversion can involve the deforestation of land and thereby the destruction of a natural sink for carbon dioxide. Intensification, on the other hand, seeks to produce more with the same amount of land. Intensification practices include changing the varieties and breeds grown on the land, altering the substances used as fertilizers, and improving irrigation practices.

Even though many measures to reduce GHG emissions are known, farmers often fail to adopt many of them. One such reason for the reluctance is that at least some farmers may not appreciate that GHGs are air pollutants and air pollution can interfere with photosynthesis, stunt overall plant growth, and ultimately lessen agricultural yields. Another reason is that the benefits that farmers can realize by changing their practices to produce reductions in GHG emissions are difficult to quantify in economic terms. To illustrate this point, a naturally-occurring substance, humate, will now be discussed.

Humates are considered to be the most widely distributed organic substance resulting from biosynthesis on the planet. These substances—found in soils, peat beds, and coal deposits and in varying concentrations in rivers, lakes, and oceans—result from the decomposition of plant and animal matter. Given their diverse origins, humates are heterogeneous substances that may contain a variety of organic components—including aromatic and heterocyclic structures, carboxyl groups, nitrogen, fragments of DNA and RNA—and inorganic components—such as minerals. Humates may possess active hydrogen bonding sites, making the humate chemically reactive. The varied humate compositions are often considered to be composed of three fractions, commonly termed humic acid, fulvic acid, and humin. Humates are often termed humic substances.

The varied chemical compositions of humates make it possible for them to have varied chemical activities and allow them to achieve various functionalities. Humates, when used as a soil amendment or conditioner, have been shown to produce various localized benefits to soil—including increased soil aeration, decreased soil density, increased soil moisture, and overall promotion of soil health—and to plants—including increased root density, increased root depth, and increased nutrient uptake. Overall, the use of this naturally occurring substance in agricultural production can reduce the need for nitrogen fertilizers—thereby reducing the N₂O emissions and CO₂ emissions associated with the production and application of such materials—and the same amounts of water needed by crops grown on soils on which humates have not been applied. Humates may also be used in efforts to remove toxins from soils and make the solid suitable for other uses. This global benefit of decreasing carbon emission by using humate during agriculture production demonstrates the localized benefit that is derived from crops grown with more natural-occurring levels of humate.

Carbon credits and carbon markets are components of national and international programs to reduce the growth in concentrations of greenhouse gases. One carbon credit is equal to one ton of carbon dioxide, or in some markets, gases that are equivalent to carbon dioxide. By capping greenhouse gas emissions, markets are established by which emissions can be financially transferred. Those who seek to emit more GHGs than they are permitted must purchase credits from those who have carbon credits, for example, by reducing their own carbon emissions.

Because GHG mitigation projects can generate credits, and therefore have financial value, an individual or company may be able to quantify the true cost of a carbon reduction strategy and obtain the financial backing to undertake it. For example, a famer seeking to apply a humic substance may find that the cost of the humic substance is higher than the cost of a synthetic fertilizer. However, the farmer also may determine that, by applying a humic substance instead of the synthetic fertilizer, the GHG emissions from the farming operation will decrease in the short run and in the long run. In the short run, the nitrous oxide emissions from the use of synthetic fertilizers will be eliminated. In the longer run, given that humic substances can improve the water retention capacity of soils, the need for irrigation may be lessened, thereby reducing carbon dioxide emissions. A farmer that can certify the application of such a substance and therefore the reduction in GHG emissions can use the reduction to generate a credit that can be sold. The financial return can aid the farmer to reduce the cost of the taking on the strategy.

A demand therefore exists for a system and methods to certify, quantify, verify, register, track and monetize the use and benefits derived from a naturally-occurring substance. Additionally a demand exists for system and methods through the use of which the benefits produced on agricultural land may be organized, quantified, compared, and managed. The present invention satisfies these demands.

### SUMMARY OF THE INVENTION

The present invention is a system and methods that facilitates the identification and management of benefits derived from the use of a naturally-occurring substance. One example of such a naturally-occurring substance is a humate.

Certain preferred embodiments of the present invention facilitate the certification, quantification, verification, registration and monetization of such benefits for a selected naturally-occurring substance.

Certain preferred embodiments of the certification process seek to establish a certification of origin—for example, the location or source from which the selected substance was derived. Other preferred embodiments of the certification process seek to establish a certification of composition, that is, the chemical composition of the selected substance.

For example, the certification of origin for a humate may confirm that it was obtained from a certain area, mine, deposit, site, or stratigraphic level. Other information may be available by which an individual or business selecting this humate will be able to discern that which they wish to know about the characteristics and qualities of the humate.

Certain preferred embodiments of the certification of composition for the humate may provide a non-unit specific composition certification, that is, a certification that does not inform the purchaser that the specific unit of material that the purchaser has purchased has a certain specific composition but instead that one or more test samples taken of the substance obtained from the site has a certain composition. The non-unit specific compositions may be obtained from one analysis conducted of one test sample or may represent an estimate based on the mathematical mean of a plurality of analyses run for a plurality of test samples.

Certain preferred embodiments of the certification of composition for the humate may provide a unit specific composition certification, that is, a certification that informs the purchaser that the specific unit of material that the purchaser has purchased has a certain specific composition. A unit specific composition certification may be based on the analyses conducted on one or more test samples taken of the unit of substance actually purchased by the purchaser.

Such certification information, in certain preferred embodiments of the present invention, may be transformed into data that can be entered into one or more certification databases or registries and used to track the identity and verify the characteristics of the substance once it leaves its origination site. The availability of such information is critical in providing a credible basis for identifying and monetizing the benefits that the use of the naturally-occurring substance is providing in reducing GHG emissions.

Another embodiment of the certification step may determine and provide notice of the potential benefits that may be derived from the use of the substance, including from the use of third party content, data, and services.

The verification step may be connected to the certification step such that the naturally-occurring substance is uniquely identified through a unique identifier—such as a QR Code, bar code, RFID tag—by which, not only the substance, but also the benefit derived from the application of the substance may be tracked.

One preferred embodiment of the registration step seeks to allow a registrant to establish that the registrant has the right to a certain benefit that was verified. This step may be used also to confirm some or all of the benefits that the registered right provides. For example, the registrant may provide an option with respect to the right, license or wholly transfer title to the benefit or allow a lien to be placed on the benefit.

One preferred embodiment of the monetization step allows one to offer, sell, donate, etc. the benefit that is the subject of the registered title. A certain embodiment of the monetization step facilitates the offering and sale of the registered benefit.

A preferred embodiment of the invention includes a system and methods by which the creation of values and realization of benefits derived from natural-occurring substances may be coordinated.

Another preferred embodiment of the invention provides a standardized system by which the source of a specific naturally-occurring substance may be tracked from origination to application.

Another preferred embodiment of the invention permits those sourcing the naturally-occurring substances to facilitate the offering and capture of benefits to customers. For example, the use of certain naturally-occurring substances produces environmental benefits. By offering these substances for sale, the substance sourcing agents or manufacturers are additionally offering for sale the environmental benefits. Through the use of these embodiments, environmental benefits can be monetized into securities, thereby creating financial benefits.

Another preferred embodiment of the verification step seeks to verify the creation and application of benefits derived from the use of certain natural-occurring substances.

Another preferred embodiment of the invention focuses on the users of the naturally-occurring substance. By applying the substance and registering the application, a user may receive a new source of revenue.

Another embodiment of the invention facilitates the establishment of a relationship between the substance sourcing agent or manufacturer and the users of the naturally-occurring substance including the capture and management of the benefits. For example, the relationship may be a business entity for this purpose.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the present application.

### BRIEF DESCRIPTION OF THE DRAWINGS

FIG. 1 illustrates a flowchart of one of the preferred embodiments of the present invention system from the perspective of a substance supplier.

FIG. 2 is a flowchart of another preferred embodiment of the present invention showing a routine from the perspective of a customer.

FIG. 3 is a flowchart of another preferred embodiment of the present invention showing an additional routine.

FIG. 4 is a flowchart of an additional preferred embodiment showing the operation of a system according to the present invention.

FIG. 5 is a flowchart of an added preferred embodiment showing the operation of another system according to the present invention.

FIG. 6 is a flowchart of one embodiment of a computing device that may implement one or more steps of the present invention.

FIG. 7 is a flowchart of another embodiment of a computing device that may implement one or more steps of the present invention.

FIG. 8 is a flowchart of another embodiment for the management of an asset.

### DETAILED DESCRIPTION OF EMBODIMENTS OF THE INVENTION

In one aspect, the present invention provides a system and methods to identify, certify, quantify, verify, register, track and monetize the use and benefits derived from naturally-occurring substances. In another aspect, the present invention provides a system and methods to define, organize, quantify, compare and manage benefits produced from the use of a naturally-occurring substance in a particular context or on a particular area of land. For purposes of this application, a naturally-occurring substance is one that may be used in a raw state, semi-raw state (for example, subjected to certain limited manipulation, milling, crushing, or filtering), or processed state (for example, subjected to more extensive manipulation, milling, crushing, or filtering).

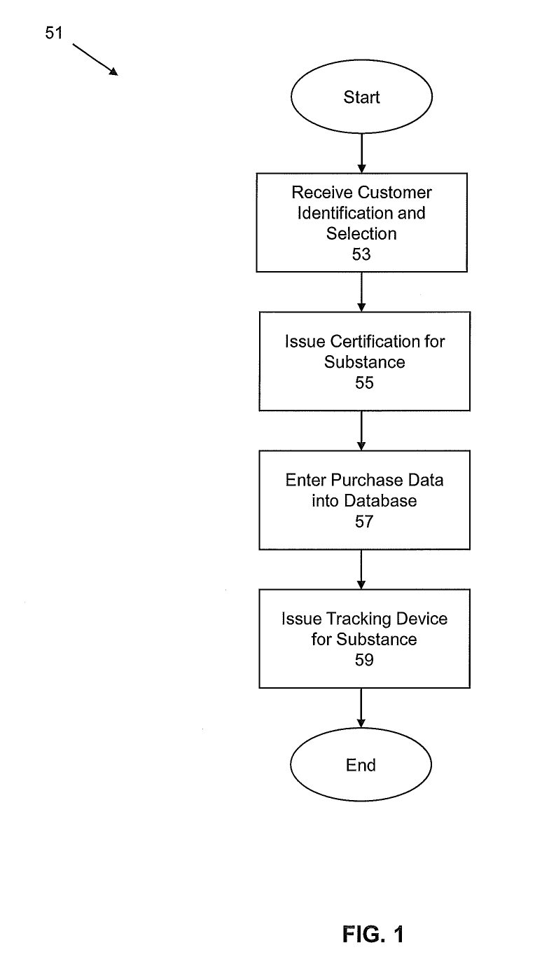

Shown in FIG. 1 is one of the preferred embodiments of the present invention by which a substance selected by a customer can be identified and certified and information recorded such that the substance may be tracked during the course of its use and the use of the benefits and value derived from the use of the substance also tracked. In block 53 of routine 51 shown in FIG. 1, the supplier receives information identifying the customer and the selection of the naturally-occurring substance. The customer may be, for example, the farmer who seeks to apply the certain selected substance to a certain track of land. The customer may also be a coordinator that is seeking to obtain selected substance for application by a plurality of farm operations.

In block 55, certification is issued for the selected substance. The certification may be a certification of origin—that is, the substance that is provided to the customer has come from a certain area, mine, deposit, site, or stratigraphic level. The certification may be non-unit specific composition certification or a unit specific composition certification. The supplier may charge an additional amount depending on the details of the certification requested by the customer.

Data regarding the purchase—that is, information identifying the customer, the substance that was selected, and the certification issued for the substance—may be entered into a database in block 57. The database may be secured to provide access only to those receiving approval by the customer. The database may be that of the supplier or a third-party registry, or both.

In block 59, a tracking device is issued. The tracking device may be one that may be applied to a unit or units of the substance—such as, but not limited to a QR Code, bar code, RFID tag. The tracking device may also be in the nature of a property title. The tracking device may provide information which the customer approves for release or data by which such information may be readily derived. Such information may include not only the substance, but also the customer, the certification issued for the substance, and the benefit derived from the application of the substance.

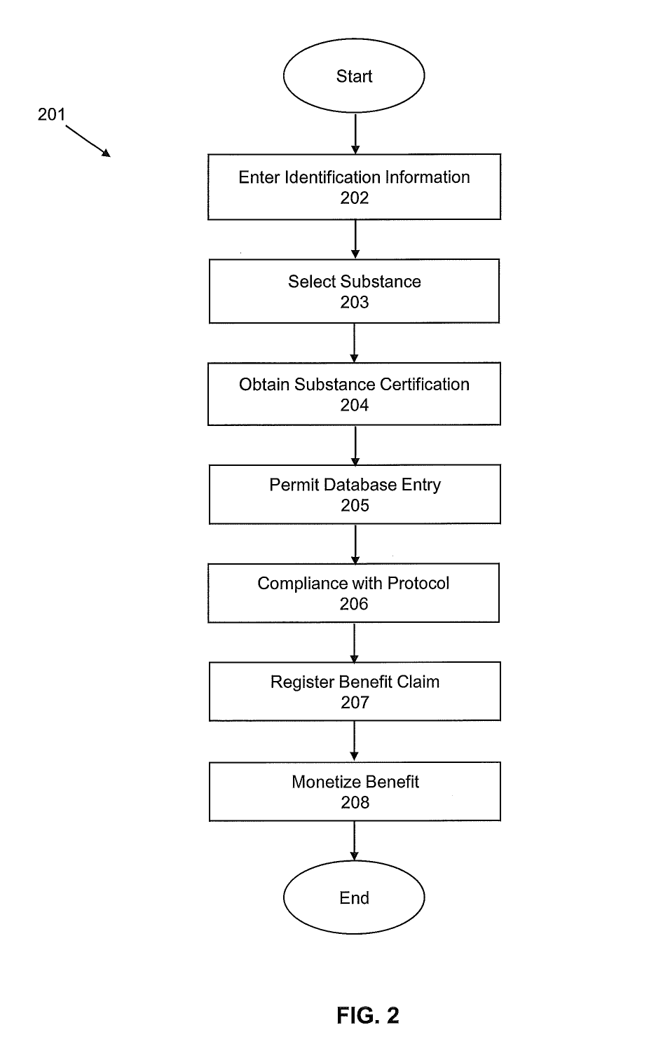

FIG. 2 illustrates one of the preferred embodiments of the present invention from the perspective of the customer seeking to obtain and use a naturally-occurring substance. In block 202 of routine 201, the customer provides identification information to the supplier. This step, as other steps of the present invention, may be provided through one or more screens of a user interface provided on the display of a computer-based system.

The customer may then select the substance that the customer may wish to purchase 203. The customer's selection may be assisted by information provided, for example, through the display user interface showing the benefits that the customer may realize by purchasing a certain substance and using it according to a suggested protocol. Such benefits may include the carbon credit that may be available from the use of a certain substance and that credit's current market value.

In block 204, the customer may identify and obtain the certification for the substance. The certification may be a certification of origin, a non-unit specific composition certification, or a unit specific composition certification. Information regarding how the choice of the certification may impact on the benefits received by the customer may be provided to the customer, such as through a user interface display.

The customer then confirms and allows the entry of the purchase information, for example, into the supplier database or a registry 205. The database may be that of the supplier or a third-party registry, or both.

The customer then verifies that, after receipt of the purchased unit or units of the substance, the customer used them according to a certain recommended method or protocol 206. In certain cases, compliance with a given protocol may be necessary to obtain the benefit sought by the customer.

The benefit to the claim from the use of the selected substance may then be advertised by the customer or registered with a third-party service 207. In certain embodiments, such advertisement or registry may constitute an offer by the customer seeking to draw a bid by a third party who seeks to obtain the subject benefit for personal use or monetize it.

In block 208, the benefit is monetized. The monetization may be arranged by the customer with a third party seeking to obtain the benefit for personal use or may be with a coordinator or aggregator seeking to act as a broker with respect to one or more separate customer benefits.

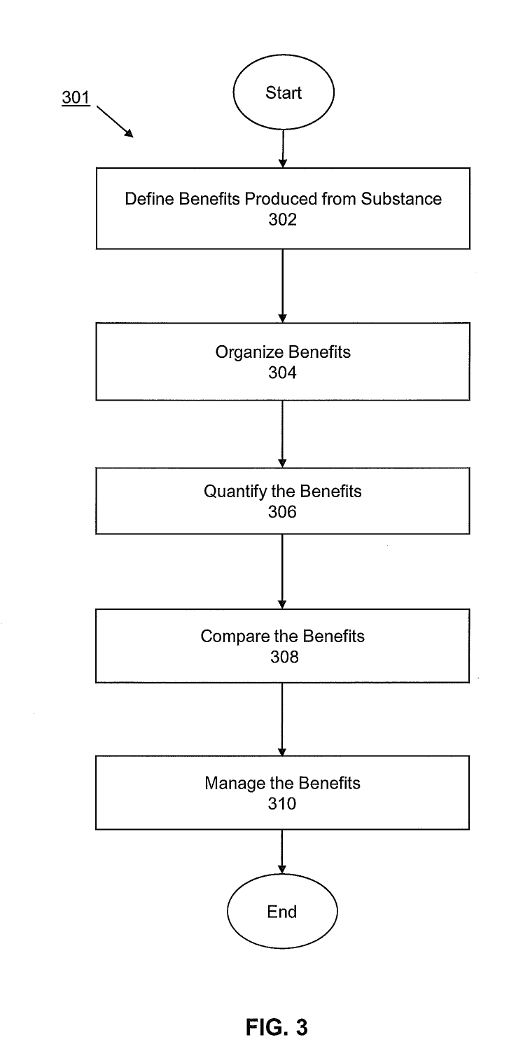

In FIG. 3, a preferred embodiment of the present invention is shown. The illustrated embodiment of the method 301 includes the steps of defining benefits producing from the substance naturally-occurring on a particular area 302, organizing the benefits 304, quantifying the benefits 306, comparing the benefits 308, and managing the benefits 310.

In block 302, a user, such as a farmer deriving the benefits from using the substance or the manufacturer who produces the substance that provides environmental, localized and monetary benefits, will first provide notice of the use of land both in regard to quantity of land used and purpose of land use (not shown). The use of the land as provided will then facilitate the definition of the benefits produced upon the land 302. These benefits may include the global environmental benefits as well as the localized benefits. The benefits may then be organized 304 into a manageable and readable format that provides for the various opportunities to monetize the benefits with the involvement of, for example, the government, private, commercial or local entity. The benefits may then be quantified 306 based on the projected benefits. The benefits may then be compared 308 and valued relative to similar benefits monetized, for example, by different trading entities. Finally, the benefits are managed 310, for example, offered for sale or traded as one or more monetary securities with the government or a private entity.

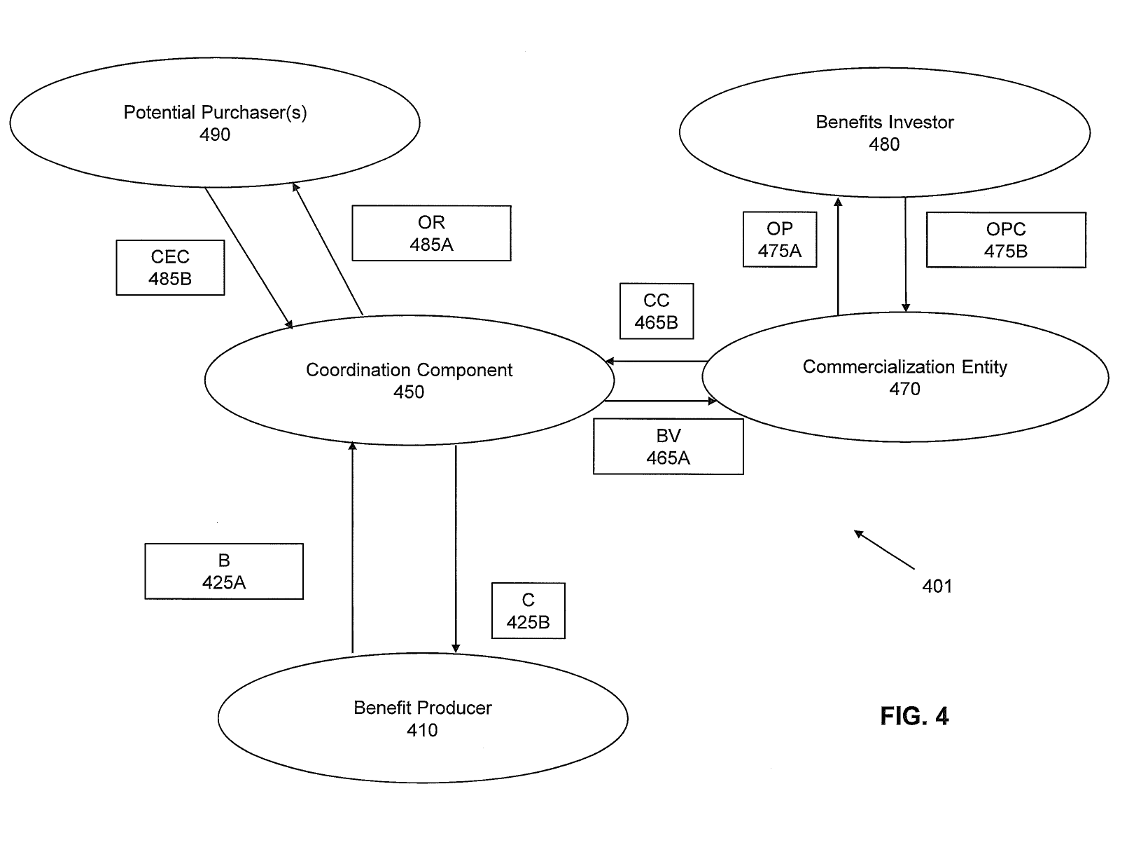

FIG. 4 illustrates an additional preferred embodiment of the system 401 according to the invention that includes a coordination component 450 by which the development and monetization of benefits from the application of a naturally-occurring substance may be coordinated. One such benefit is the carbon offset credits or other benefits derived from the application of humates to agricultural land or other area. The coordination component 450 may be any individual or organization, including a non-profit organization, such as a university. The benefits may be used to produce other benefits, such as through the monetization of the carbon offset credits to produce tax benefits. These benefits may be used to incentivize expansion of participation in carbon offset purchases to individuals and businesses with a charitable intent rather than a strictly business purpose. The coordination component 450 may be used to facilitate other commercialization and monetization objectives including the coordination of the offering of other grants of rights such as through options or licenses to contractual or intellectual property rights in projects. The coordination component 350 may be structured relative to other components of the system in a variety of ways including through a “hub and spoke” structure. Among the benefits that may be obtained through the use of the system 401 are the following: 1) potential for carbon offset purchasers to possibly obtain charitable contribution or business expense deduction, 2) University or general 501(c)(3) entity may benefit from matching the carbon offset buyers to the end users, and 3) Agricultural products companies may benefit from increased demand for their products. In return, the companies may assist with the verification documentation requirements.

More specifically, FIG. 4 illustrates an embodiment of the system that includes a benefit producer 410, that is, one or more individuals or entities that have a substance, property, or relationship from which a benefit “B” has been produced or can be produced from the use of the naturally-occurring substance. The benefit producers 410 may offer or provide 425A one or more such benefits “B” to a coordination component 450 for the proposed or actual exchange 425B of some consideration “C”. The coordination component 450 may communicate the details of the benefit “B” to a commercialization entity 470 that can be provided with the authorization or right, for example, to offer or provide or otherwise commercialize or monetize 465A the benefit “B” either outright or transform it into some other benefit vehicle (collectively shown as “BV”). In exchange for the BV, the commercialization entity 470 can transfer 465B consideration “CC” of some type and amount so that the coordination component 450, and ultimately the benefit producer 410 may each obtain value. The commercialization entity 470 may offer an opportunity (including right) “OP” to investor 480. The investor 480 may have obtained additional value from such opportunity OP and provides consideration “OPC” for the transfer of opportunity OP. The coordination component 450 may provide 485A one or more benefits to other consuming entities 490, including those who may seek to purchase opportunities or rights “OR” derived more immediately from the actions of the benefit producer 410 in order that the consuming entities may meet immediate or long term needs. One such opportunity is the carbon offset credit that may be produced by a benefit producer 410—for example, a farmer—who applies a humate and thereby avoids the need for chemical fertilizers and traditional amounts of water. The consuming entity 490 may use the purchased benefit “OR” to offset the consuming entity's carbon production or offer the OR to one or more other consuming entities 490. Consuming entities 490 transfer 485B consideration “CEC to the coordination component 450 for the OR 485A.

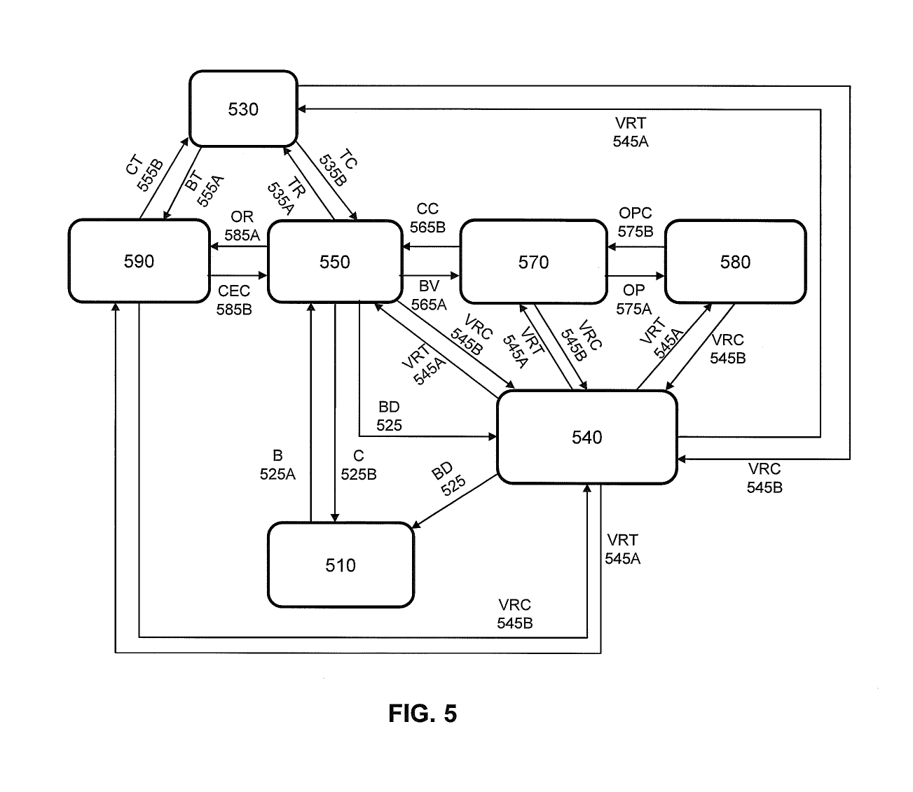

FIG. 5 illustrates another embodiment of the present invention that includes a third party verification service component 540 by which information regarding the substance, property, or relationship from which the benefit is produced may be verified. The verification component 540 in certain embodiments may be a registry or database in which information regarding the substance, its use, the property, and/or the various relationships that may be involved in the same may be stored for access as permitted. More specifically, the FIG. 5 illustrated embodiment 501 includes a producer 510, that is, one or more individuals or entities that have a substance, property, or relationship from which a benefit “B” has been produced or can be produced. The benefit producer 510 may offer or provide 525A one or more such benefits “B” to a coordination component 550 in exchange 525B for the receipt of some consideration “C”. The producer 510 and/or the coordination component 550 may transfer information BD 525 including data by which the identity of the producer 510 and the substance, property, or relationship from which the benefit is produced may be verified. The coordination component 550 may communicate the details of the benefit “B” to a commercialization entity 570 that can be provided with the authorization or right, for example, to offer or provide or otherwise commercialize or monetize 565A the benefit “B” either outright or transform it into some other benefit vehicle (collectively shown as “By”). In exchange for the BV, the commercialization entity 570 can transfer 565B consideration “CC” of some type and scale so that the coordination component 550, and ultimately the benefit producer 510 may each obtain value. The commercialization entity 570 may offer an opportunity (including right) “OP” to investor 580. The investor 580 may obtain additional value from such opportunity OP 575A and provides consideration OPC 575B for the transfer of opportunity OP. Further, the coordination component 550, commercialization entity 570, the investor 580, consuming entity 590, and trading entity 530 may exchange 545A consideration VRC” to a third party verification entity 540 in exchange 545B for a verification report VRT. The coordination component 550 may provide 585A one or more benefits to other consuming entities 590, including those who may seek to purchase opportunities or rights “OR” derived more immediately from the actions of the benefit producer 510 in order that the consuming entities may meet immediate or long term needs. Additionally, the coordination component 550 may provide one or more benefits 535A to a third party trading entity 530 who seek to trade rights “TR” in the benefit or benefits in exchange for consideration TC 535B. The consuming entities 590 may then exchange consideration CT 555B to the trading entity 530 in exchange for the benefit or benefits from the trading entity BT 555A. One such opportunity is the carbon offset credit that may be produced by the benefit producer 510 who applies, for example, a humate and thereby avoids the need for synthetic fertilizers and traditional amounts of water. The consuming entity 590 may use the purchased benefit “OR” to offset the consuming entity's carbon production or offer the OR to one or more other consuming entities 590. Consuming entities 590 transfer consideration CEC 585B to the coordination component 550 for the OR 585A.

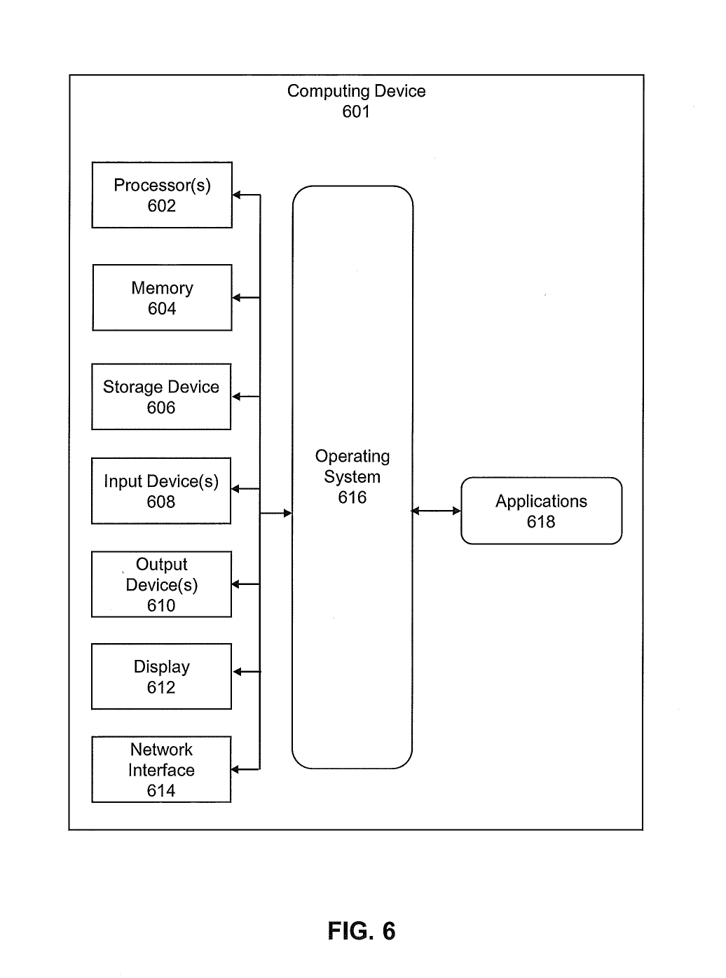

FIG. 6 is a flowchart of another embodiment of a computing device that may implement one or more steps of the present invention. Computing device 601 is an example of a computing device that may be configured to transmit data to and receive data from communication network 604 and execute one or more applications 618. Computing device 601 may include or be part of a portable computing device (e.g., a mobile phone, netbook, laptop, personal data assistant (PDA), or tablet device) or a stationary computer (e.g., a desktop computer, or set-top box), or may be another computing device. Computing device 601 includes processor(s) 602, memory 604, storage device 606, input device(s) 608, output device(s) 610, display 612, and network interface 614. Each of processor(s) 602, memory 604, storage device 606, input device(s) 608, output device(s) 610, display 612, and network interface 614 may be interconnected (physically, communicatively, and/or operatively) for inter-component communications. Operating system 616 and applications 618 may be executable by computing device 601. It should be noted that although example computing device 601 is illustrated as having distinct functional blocks, such an illustration is for descriptive purposes and does not limit computing device 601 to a particular hardware architecture. Functions of computing device 601 may be realized using any combination of hardware, firmware and/or software implementations.

Processor(s) 602 may be configured to implement functionality and/or process instructions for execution in computing device 601. Processor(s) 602 may be capable of retrieving and processing instructions, code, and/or data structures for implementing one or more of the techniques described herein. Instructions may be stored on a computer readable medium, such as memory 604 or storage device 606. Processor(s) 602 may be digital signal processors (DSPs), general purpose microprocessors, application specific integrated circuits (ASICs), field programmable logic arrays (FPGAs), or other equivalent integrated or discrete logic circuitry.

Memory 604 may be configured to store information that may be used by computing device 601 during operation. As described above, memory 604 may be used to store program instructions for execution by processor(s) 602 and may be used by software or applications running on computing device 601 to temporarily store information during program execution. For example, memory 604 may store instructions associated with operating system 616, applications 618 or components thereof, and/or memory 604 may store information associated with the execution of operating system 616 and applications 618. Memory 604 may be described as a non-transitory or tangible computer-readable storage medium. In some examples, memory 604 may provide temporary memory and/or long-term storage. In some examples, memory 604 or portion thereof may be described as volatile memory, i.e., in some cases memory 604 may not maintain stored contents when computing device 601 is powered down. Examples of volatile memories include random access memories (RAM), dynamic random access memories (DRAM), and static random access memories (SRAM).

Storage device 606 represents memory of computing device that may be configured to store relatively larger amounts of information for relatively longer periods of time than memory 604. Similar to memory 604, storage device 606 may also include one or more non-transitory or tangible computer-readable storage media. Storage device 606 may be internal or external memory and in some examples may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

Input device(s) 608 may be configured to receive input from a user operating computing device 601. Input from a user may be generated as part of a user running one or more software applications, such as applications 618. Input device(s) 608 may include a touch-sensitive screen, track pad, track point, mouse, a keyboard, a microphone, video camera, or any other type of device configured to receive input from a user. In one example, input device(s) 608 may generate one or more signals corresponding to the coordinates of a position touched on a touchscreen of computing device 600. These signals may be provided as information to components of computing device 600 (e.g., processor 602, or operating system 616) in conjunction with the execution of applications 618.

Output device(s) 610 may be configured to provide output to a user operating computing device 601. Output may tactile, audio, or visual output generated as part of a user running one or more software applications, such as applications 618. Output device(s) 610 may include a touch-sensitive screen, sound card, a video graphics adapter card, or any other type of device for converting a signal into an appropriate form understandable to humans or machines. Additional examples of an output device(s) 610 may include a speaker, a cathode ray tube (CRT) monitor, a liquid crystal display (LCD), or any other type of device that can provide output to a user. In some examples, output device(s) 610 may be external to computing device 601 and may be operatively coupled to computing device 601 using a standardized communication protocol, such as for example, Universal Serial Bus protocol (USB) or High-Definition Multimedia Interface (HDMI).

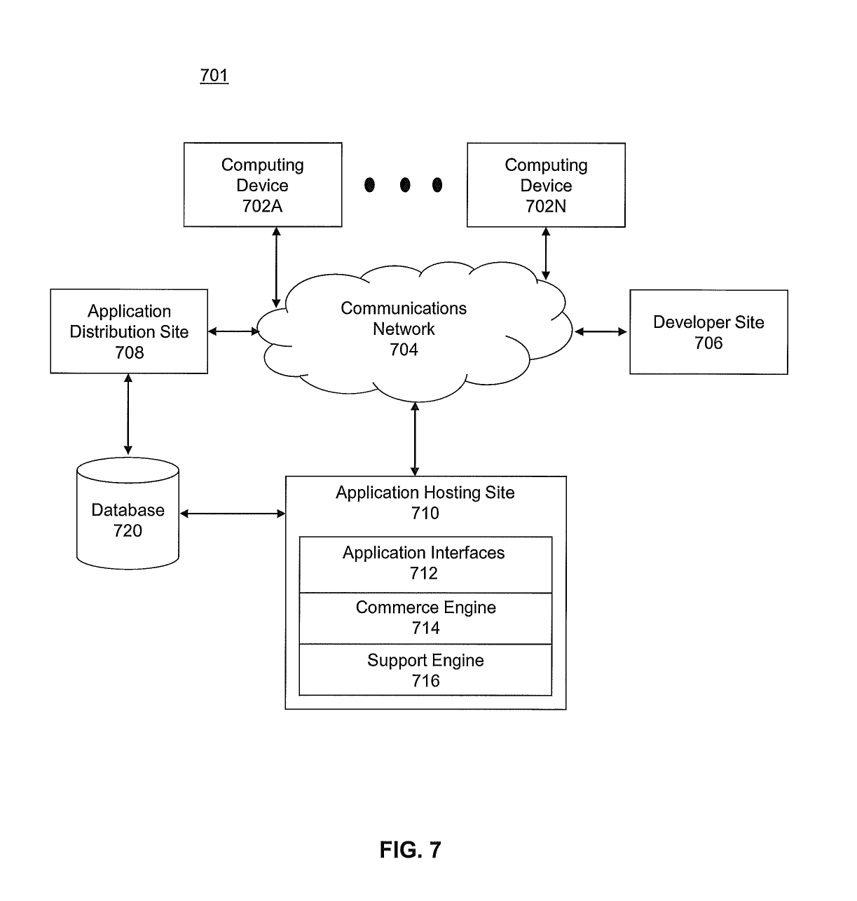

FIG. 7 is a block diagram illustrating another embodiment of the system that may implement one or more steps of this disclosure. In the example illustrated in FIG. 7, system 701 includes one or more computing devices 702A-702N, communications network 704, developer site 706, application distribution site 708, and application hosting site 710. Application hosting site 710 may include application interface 712, commerce engine 714, and support engine 716. Further, as illustrated in FIG. 7, application distribution site 708 and application hosting site 710 may be connected to database 720. System 701 may include software modules operating on one or more servers. Software modules may be stored in a memory and executed by a processor. Servers may include one or more processors and a plurality of internal and/or external memory devices. Examples of memory devices include file servers, an FTP servers, network attached storage (NAS) devices, a local disk drive, or any other type of device or storage medium capable of storing data. Storage medium may include Blu-ray discs, DVDs, CD-ROMs, flash memory, or any other suitable digital storage media. When the techniques described herein are implemented partially in software, a device may store instructions for the software in a suitable, non-transitory computer-readable medium and execute the instructions in hardware using one or more processors.

System 701 represents an example of a system that may be configured to allow software applications to be developed, distributed, and executed on a plurality of computing devices, such as computing devices 702A-702N. In the example illustrated in FIG. 7, computing devices 702A-702N may respectively include any device configured to transmit data to and receive data from communication network 704. For example, computing devices 702A-702N may be equipped for wired and/or wireless communications and may include desktop or laptop computers, mobile devices, smartphones, cellular telephones, set top boxes, and personal gaming devices.

Communications network 704 may comprise any combination of wireless and/or wired communication media. Communication network 704 may include routers, switches, base stations, or any other equipment that may be useful to facilitate communication between various devices and sites. Communication network 704 may form part of a packet-based network, such as a local area network, a wide-area network, or a global network such as the Internet. Communication network 704 may operate according to one or more communication protocols, such as, for example, a Global System Mobile Communications (GSM) standard, a code division multiple access (CDMA) standard, a 3rd Generation Partnership Project (3GPP) standard, an Internet Protocol (IP) standard, a Wireless Application Protocol (WAP) standard, and/or an IEEE standard, such as, one or more of the 802.11 standards, as well as various combinations thereof.

As illustrated in FIG. 7, developer site 706 is connected to communications network 704. Developer site 706 may be configured to enable one or more software developers to author, maintain, update, improve, and/or monitor software applications. Developer site 706 may be part of an organization that provides software applications. In the example where computing devices 702A-702N are mobile devices, such as, for example, smartphones, developer site 706 may be configured to provide software applications for use with a mobile device. Software applications for use with a mobile device may be referred to as apps. Developer site 706 may include one or more developer workstations (not shown) in communication with one another. Developer workstations may include any device such as, a laptop or a desktop computer capable of coding software functions. Developer workstations may include computers running an operation system, such as, for example, Linux, and/or operation systems developed by Microsoft and Apple. Developer site 706 may include any combination of hardware and software that enables developers to code software according to a specified programming language. Examples of programming languages include Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™ Jini™ C, C++, Perl, UNIX Shell, Visual Basic or Visual Basic Script, Virtual Reality Markup Language (VRML), ColdFusion™ and other compilers, assemblers, and interpreters. In some examples, developers may write software applications using a software development kit (SDK) provided by a device manufacturer or a data service provider.

As illustrated in FIG. 7, application distribution site 708 is connected to communications network 704. Application distribution site 708 may be configured to receive a developed software application and distribute a developed application to computing devices 702A-702N. Further, in some examples, application distribution site 708 may be configured to distribute supporting software to hosting site 710. In the example where one or more of computing devices 702A-702N are mobile devices, application distribution site 708 may be maintained by a mobile device manufacturer, a service provider, and/or a mobile device operating system provider. An application distribution site that is maintained by a mobile device manufacturer, a service provider, or a mobile device operating system provider may be referred to as an app store. Examples of app stores include Google Play, the Apple App Store, BlackBerry World, Windows Phone Store, and the Amazon Appstore.

As illustrated in FIG. 7, application hosting site 710 is connected to communications network 704. Application hosting site 710 is configured to support the operation of a software application on one or more of computing devices 702A-702N. For example, if a software application provides interaction between two or more of computing devices 702A-702N, application hosting site 710 may be configured to support interaction between computing devices 702A-702N. In the example illustrated in FIG. 7, application hosting site 710 includes application interface 712, commerce engine 714, and support engine 716. Application interface 712, commerce engine 714, and support engine 716 may be implemented as any of a variety of suitable circuitry, such as one or more microprocessors, digital signal processors (DSPs), application specific integrated circuits (ASICs), field programmable gate arrays (FPGAs), discrete logic, software, software modules, hardware, firmware or any combinations thereof.

Application interface 712 may be configured to provide an interface between application hosting site 710 and one or more of computing devices 702A-702N for a hosted aspect of an application. Commerce engine 714 may be configured to support transactions that may occur when a user uses a software application. Commerce engine 714 may include a number of components required for online commerce. For example, commerce engine 714 may include modules with instructions stored on a computer readable medium that when executed by a processor cause application hosting site 710 to perform functions related to customer accounts, orders, subscriptions, tax, payments, fraud, and credit processing.

Support engine 716 may be configured to provide support services associated with an application. In one example, support engine 716 may be configured to provide updates to an application installed on one of user devices 702A-702N. As illustrated in FIG. 7, database 720 is connected to application hosting site 710 and application distribution site 708. Database 720 may include any of the memory device described above. Database 720 may store information associated with the operation of an application. For example, database 720 may store user account information, multimedia associated with an application, and/or user credentials.

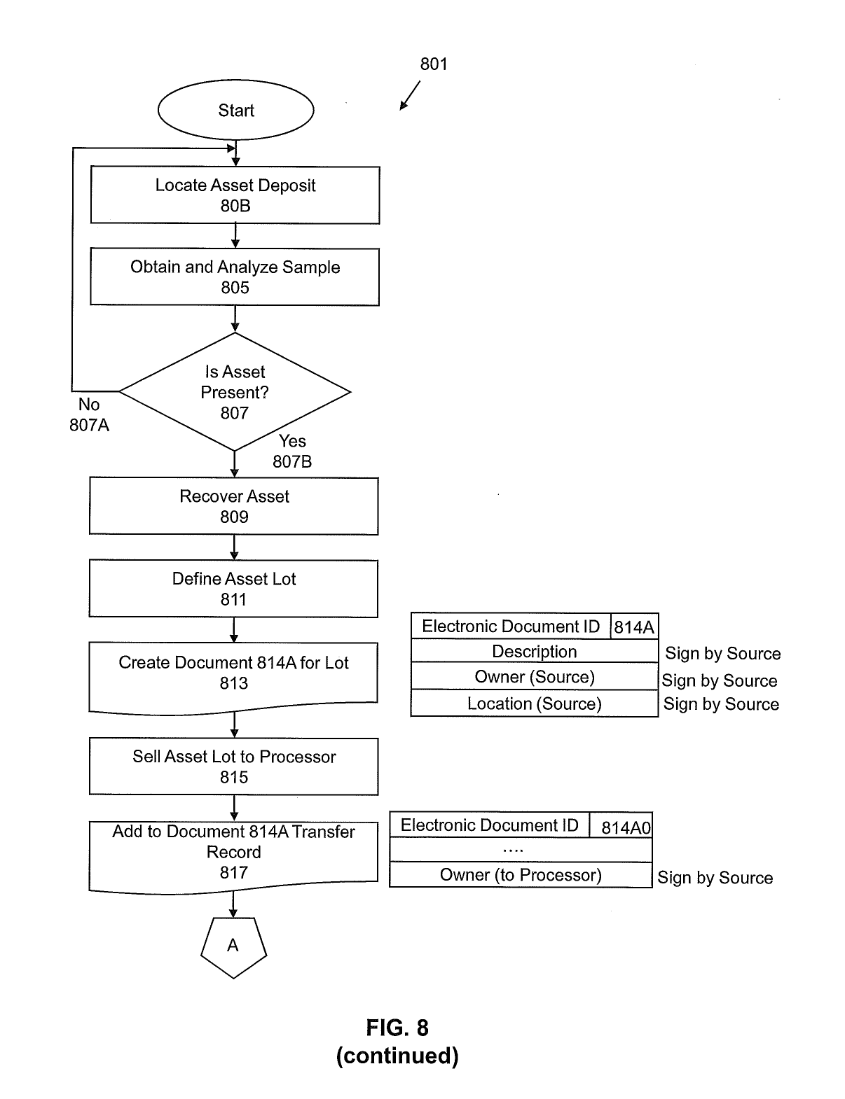

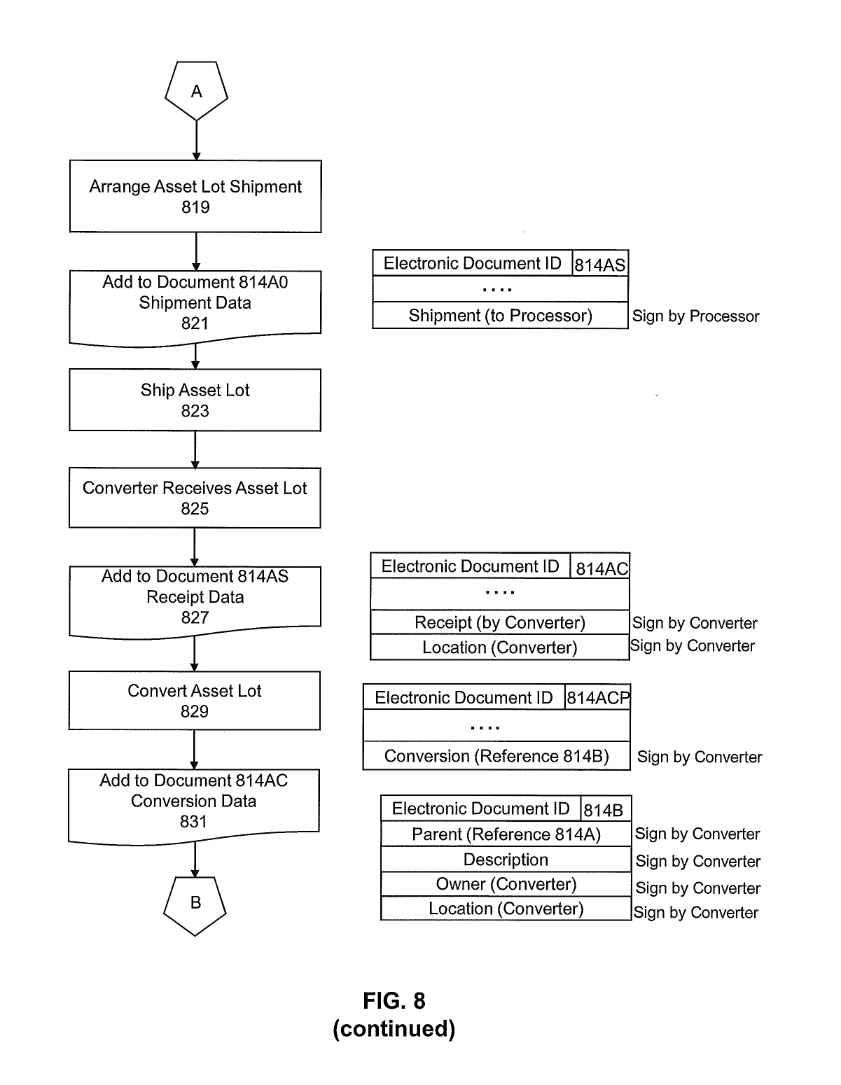

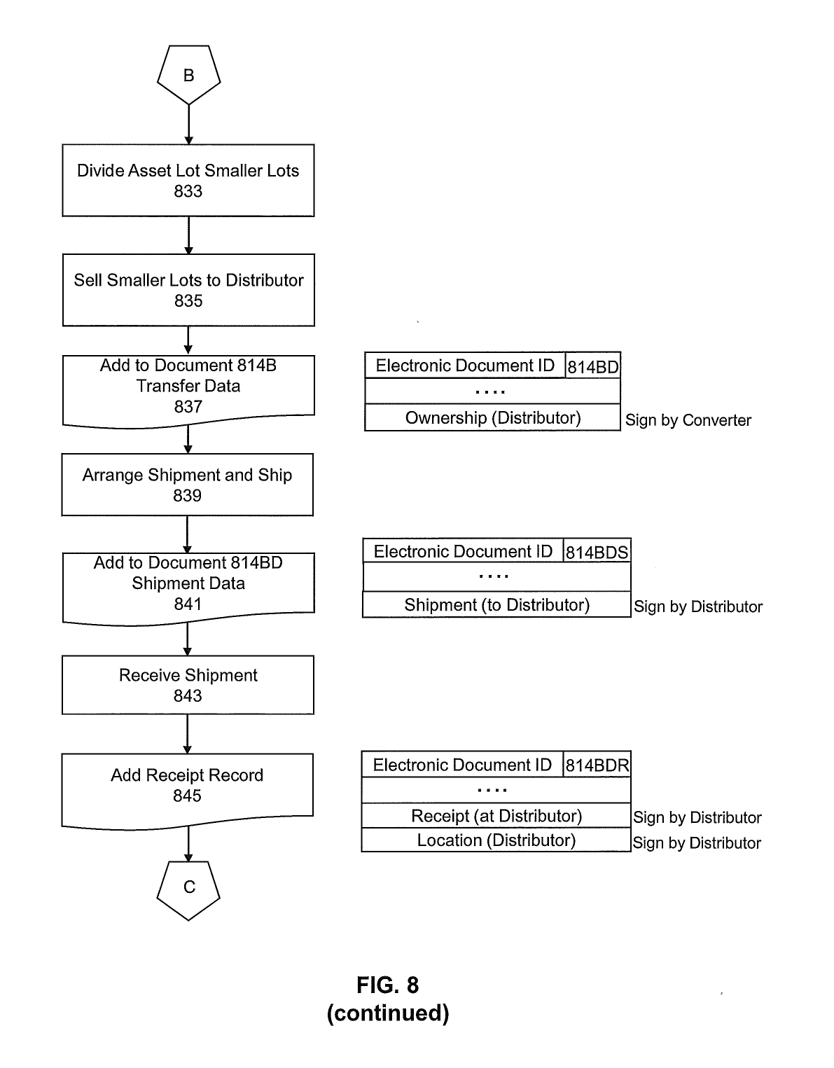

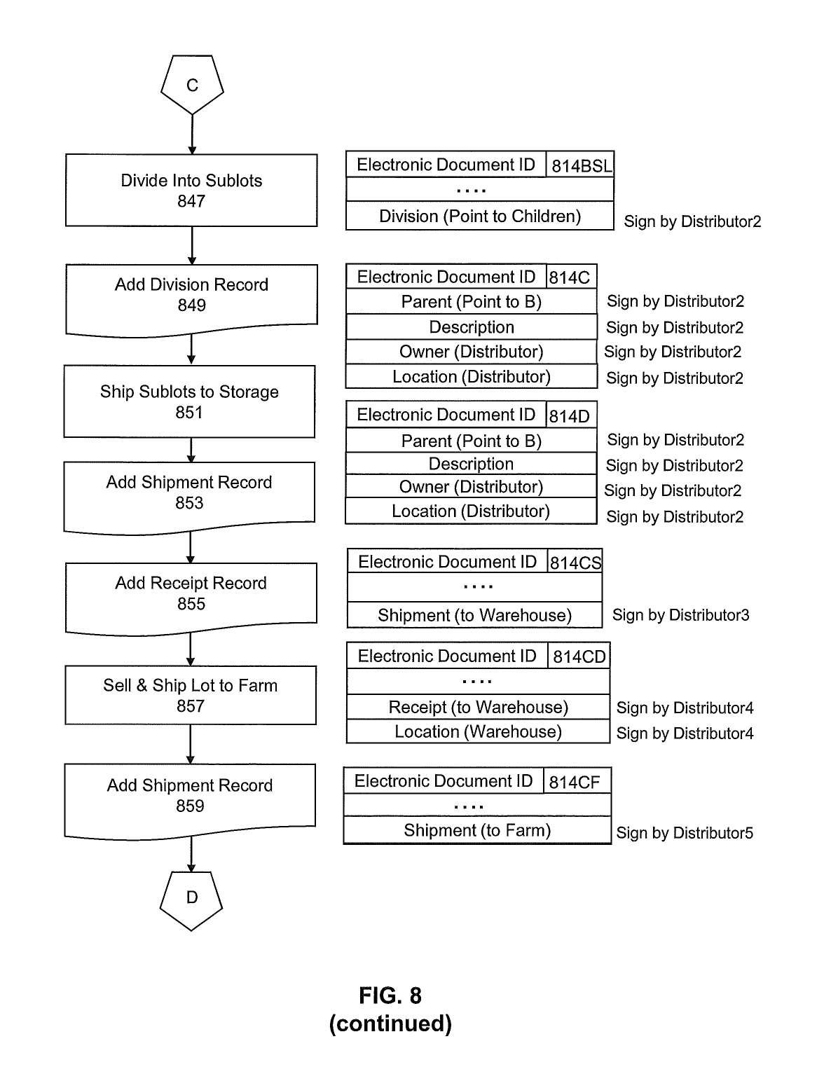

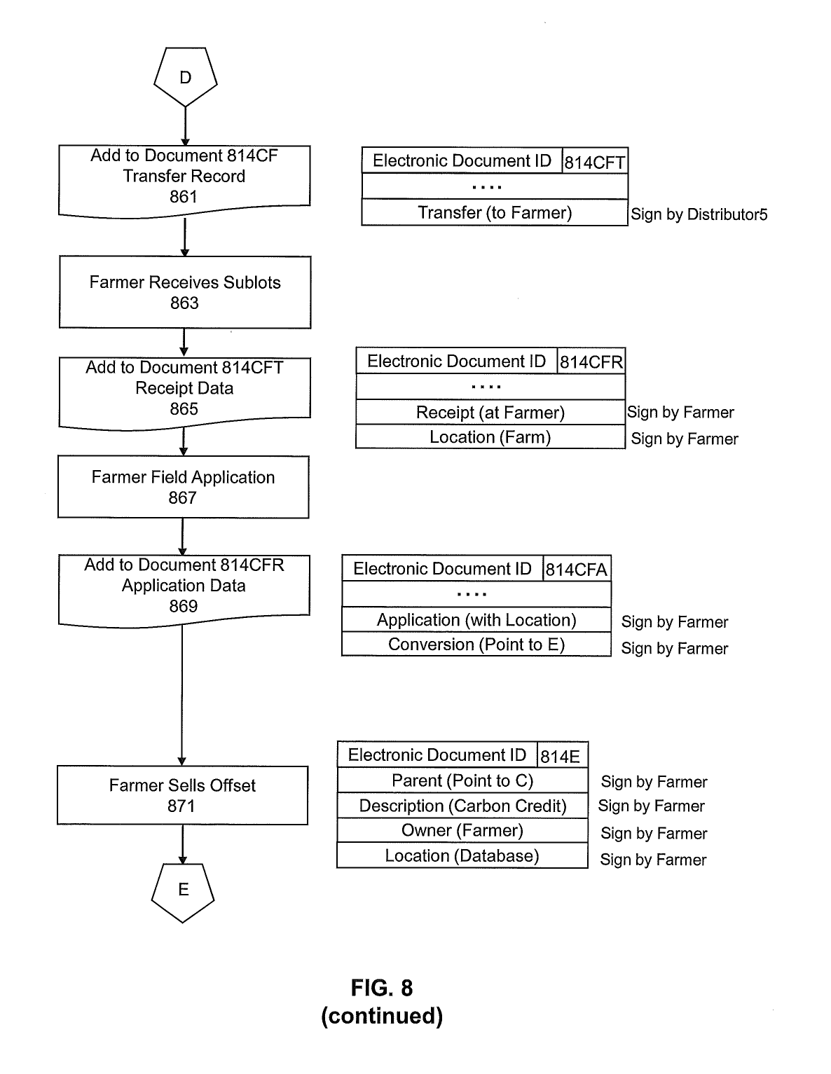

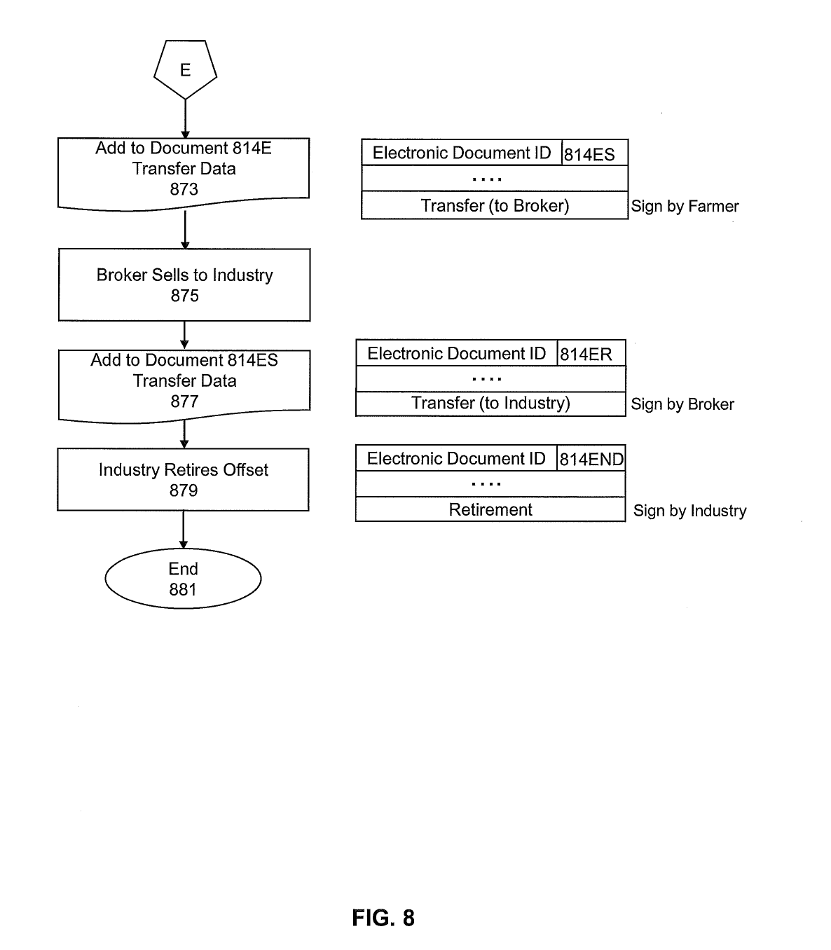

FIG. 8A through FIG. 8F illustrate the operation of a benefit management system 801 by which a tangible asset that can produce a benefit such as a carbon credit may be tracked from a source, through its development into a product, its use, and the creation of the benefit from the use. For illustration purposes, the tangible asset is one that may be sourced from a mine, deposit, or area of land, such as a humate.

In steps 803 through 807, whether a certain mine, deposit, or area may be a source of the selected asset is determined. In step 803, a possible source of the selected tangible asset is located. In step 805, one or more samples are obtained for analysis and analyzed. If the asset is within stratigraphic layers under the surface, obtaining one or more samples may require drilling and analysis of bore samples. In step 807, a determination is made whether the asset has been found in the samples at all and/or of the desired quality. If the asset has not been identified in the samples at all or the quality of the asset is less than what is sought 807A, steps 803 and 805 may be repeated. If the asset was located that may be of the desired quality 807B, the asset is recovered 809. If the asset if underground, such recovery may require mining.

In block 811, the unit of the asset that will be sent for possible processing will be defined (a “Lot”). In step 813, an asset document 814 will be created providing at least certain information for the Lot. The document 814 may be in electronic form and be able to be prepared through a user interface and a series of query boxes and drop down menus. One preferred embodiment of the asset document 814 and the information it may include is shown and identified in FIG. 8A as 814A. The information may include a description of the asset, the owner of the source from which the asset was recovered, and the location of the source.

In step 815, the asset lot is sold, for example, to a processor. The transfer of the asset lot to the processor is recorded 817 by the addition of processor information to asset document 814A to produce document 814AO that includes a confirmation from the owner of the source of such transfer to the processor.

The shipment of the asset lot from the processor to a converter is arranged 819 and with step 821 the information regarding the shipment of the asset lot is added to asset document 814AO to produce asset document 814AS. The document 814AS includes a confirmation from the processor of the shipment. The asset lot is shipped 823 to the converter 823 and received by the converter 825. Information regarding the receipt by the converter of the asset lot is added to document 814AS to produce document 814AC. This information may include confirmations by the converter of both the receipt of the asset lot and the location of the converter.

The asset lot in part or in whole is converted by or for converter 829. Information regarding the conversion performed on the asset lot is added to document 814AC to produce document 814ACP. Because the conversion may alter the properties of the asset, and therefore produce a converted asset, a new document 814B may be prepared to track the converted asset 831. The converted asset document 814B may reference asset document 814A and may include information regarding the parentage of the asset, the description of and owner of the converted asset and the location of the converter.

The converter may divide the asset lot into smaller lots 833 and sell and transfer some or all the smaller lots to a distributor 835. In step 837, information regarding the sale and transfer to a distributor is added to converted asset document 814B to produce document 814 BD that includes a confirmation from the converter of the transfer to the distributor.

The converter may then arrange for shipment and ship some or all the smaller lots to the distributor 839. In block 841, information regarding the shipment to the distributor is added to document 814BD to produce document 814BDS.

The distributor may then receive the shipment 843 and in block 845 information regarding the receipt of the shipment by the distributor is added to document 814BDS to produce document 814BDR that may include confirmation by the distributor of the receipt of the shipment and the location of the distributor.

The distributor may divide the smaller lots into sublots 847 and information regarding the division is added to document 814BDR to produce document 814BSL that confirms the division by the distributor of the sublots (termed “distributor2”). To track the sublots, new tracking documents are produced 849. If two sublots are produced, two documents 814C and 814D may be created. Each of the documents 814C, 814D may include information regarding the parent of the smaller lots that were divided, a description of the converted asset, the owner of each of the sublots, and the owner's location.

The sublots are shipped for storage 851. To each of the tracking documents, information regarding the shipment for storage is added. Illustrated is the addition of information to document 814C of the storage shipment information to produce document 814CS and may include a confirmation by the distributor that may be responsible for the distribution of the sublot (“distributor3”). The receipt by an additional distributor (distributor4) may be added to document 814CS to produce document 814CD.

The FIG. 8 embodiment assumes that the asset will be applied to a farmland. In block 857, the sublots are sold and shipped by another distributor (“distributor5”) to a farm and, in step 859, the sale and shipment is added to document 814CD to produce document 814CF that includes a confirmation by distributor5.

The transfer to the farm of the sublots are confirmed by the addition of information by distributor5 to document 814CF of the transfer details to produce document 814CFT.

In block 863, the farmer receives the sublots and in step 865 information regarding the receipt is added to document 814CFT to produce document 814CFR. The farmer then, for example, applies the asset to the farmland 867. Information regarding the application is added to document 814CFR to produce document 814CFA. Such information may include the application, whether it followed a protocol and what protocol, the location of the application, and the resultant conversion and production of a benefit such as carbon credit.

The creation of, for example, the carbon credit can be confirmed through the production of an additional document 814E. Such a document 814E may include information regarding the source of the asset and other showing the parentage that lead to the production of the credit, the description of the carbon credit, the owner of the credit (for example, the farmer or another or others to whom the farmer may have sold the credit), and the location of the farm.

In block 871, the farmer (or other owner) may sell, for example, the offet. The transfer of the offset or credit by the farmer (or other owner) may be confirmed by the addition of information to document 814E—such as the identity of, for example, the broker to whom the farm sold—to produce document 814ES.

If a broker obtained the offset, credit, or benefit, the broker may sell, for example, to an industrial party 875. In block 877, information regarding the sale is added to document 814ES to produce document 814ER. The purchaser—such as the industrial party—may employ the offset or credit or otherwise use the benefit, thereby causing a retirement of same 879. Information regarding the retirement is added to document 814ER to produce document 814END. The routine then ends 881.

What is claimed is:

1. A system implemented through use of a computer for analyzing and managing benefits derived from the use of a naturally-occurring substance, comprising:
a processor;
a memory;
a storage device;
an input device,
and output device;
a display, a network interface; and
an operating system.

2. A method that facilitates the analysis of benefits derived from use of a naturally-occurring substance, implemented through use of a computer, comprising:
determining the naturally-occurring substance of interest;
certifying source characteristics of the naturally-occurring substance;
quantifying the source characteristics into data;
verifying the data against the actual characteristics of the naturally-occurring substance;
registering the data to claim benefit; and
monetizing the benefit derived from use of the naturally-occurring substance.

3. A method that facilitates the management of benefits of derived from using a naturally-occurring substance on a particular region of land, implemented through use of a computer, comprising:
defining the benefits derived from the naturally-occurring substance;
organizing the benefits;
quantifying the benefits;
comparing the benefits; and
managing the benefits.
